(19) United States
(12) Patent Application Publication
(10) Pub. No.: US 2026/0141597 A1
(43) Pub. Date: May 21, 2026

(54) STYLIZED SKETCH APPARATUS USING GENERATIVE ADVERSARIAL NETWORK, METHOD FOR TRAINING GENERATIVE ADVERSARIAL NETWORK AND METHOD FOR EXTRACTING STYLIZED SKETCH

(71) Applicant: KOREA ADVANCED INSTITUTE OF SCIENCE AND TECHNOLOGY, Daejeon (KR)

(72) Inventors: Junyong NOH, Daejeon (KR); Kwan YUN, Daejeon (KR); Kwanggyoon SEO, Daejeon (KR); Soyeon YOON, Daejeon (KR); Ashtari AMIRSAMAN, Daejeon (KR); Chang Wook SEO, Daejeon (KR)

(21) Appl. No.: 19/240,588

(22) Filed: Jun. 17, 2025

(30) Foreign Application Priority Data
Nov. 15, 2024 (KR) 10-2024-0163388

(51) Int. Cl. G06T 11/60; G06N 3/0475; G06V 10/82

(52) U.S. Cl. CPC G06T 11/60; G06N 3/0475; G06V 10/82

(57) ABSTRACT

In accordance with an embodiment, there is provided a method for training a generative adversarial network for a stylized sketch, the method comprising: projecting an image, from a dataset including sketch-image pairs, into a latent space of a first generator model of the generative adversarial network; applying a deep feature map of the first generator model to a second generator model of the generative adversarial network, using a latent code obtained in projecting the image into the latent space; and training the second generator model using a sketch, among the dataset, corresponding to the deep feature map and a discriminator model of the generative adversarial network.

### CROSS REFERENCE TO RELATED APPLICATION

The present application claims priority to Korean Patent Application No. 10-2024-0163388, filed on Nov. 15, 2024, the entire contents of which are hereby incorporated by this reference.

### BACKGROUND OF THE INVENTION

### Field of the Invention

The disclosure relates to a stylized sketch apparatus using a generative adversarial network, a training method for the generative adversarial network, and a method of extracting a stylized sketch using the trained generative adversarial network.

This work was supported by Korea Creative Content Agency grant funded by the Korea government (Ministry of Culture, Sports and Tourism) (Project unique No.: 2370000036; Project No.: 00228331; R&D project: Global Virtual Performance Core Technology Development; Research Project Title: Development of a universal fashion creation platform technology for expressing avatar individuality; and Project period: 2024.01.01.˜2024.12.31.)

### Description of the Related Art

Face sketches are used in various application fields, such as criminal investigation, character design, and educational training, and in addition thereto, there is a demand for reconstructing or editing realistic face images from sketches.

In case where an artificial neural network is to be used to extract stylized sketches according to conventional techniques, an enormous amount of sketch data was required to train the corresponding artificial neural network, and since it was difficult to secure the required sketch data, this became a significant limitation in actual application.

### SUMMARY OF THE INVENTION

According to an embodiment, generative adversarial there is provided a method for training a generative adversarial network for a stylized sketch, in which a feature map of a generator model projected with an image from a dataset including sketch-image pairs is applied to a new generator model, thereby enabling training of the generative adversarial network using a relatively small amount of sketch data.

In addition, there are provided a stylized sketch apparatus using a generative adversarial network including a generator model to which a feature map of the generator model projected with an image among the dataset is applied, and a method of extracting a stylized sketch by the apparatus.

However, the problem to be solved by the present disclosure is not limited to that mentioned above, and other problems to be solved that are not mentioned may be clearly understood by those of ordinary skill in the art to which the present disclosure belongs from the following description.

In accordance with a first aspect of a method for training a generative adversarial network for a stylized sketch, the method comprising: projecting an image, from a dataset including sketch-image pairs, into a latent space of a first generator model of the generative adversarial network; applying a deep feature map of the first generator model to a second generator model of the generative adversarial network, using a latent code obtained in projecting the image into the latent space; and training the second generator model using a sketch, among the dataset, corresponding to the deep feature map and a discriminator model of the generative adversarial network.

In accordance with a second aspect of a method for extracting a stylized sketch using a stylized sketch apparatus based on a generative adversarial network, the generative adversarial network including a first generator model, a second generator model, and discriminator model, the method comprising: projecting an image, from a dataset including sketch-image pairs, into a latent space of the first generator model; applying a deep feature map of the first generator model to the second generator model, using a latent code in which the image is projected; training the second generator model using a sketch, among the dataset, corresponding to the deep feature map and the discriminator model; acquiring an image having an identity and structure as an output of the first generator model; and acquiring a sketch having the identity and the structure as an output of the second generator model.

In accordance with a third aspect of a stylized sketch apparatus based on a generative adversarial network, the generative adversarial network including a first generator model, a second generator model, and discriminator model, the apparatus comprising: a memory storing at least one instruction; and a processor executing the at least one instruction stored in the memory, wherein the at least one instruction, when executed by the processor, causes the processor to: project an image, from a dataset including sketch-image pairs, into a latent space of the first generator model; apply a deep feature map of the first generator model to the second generator model, using a latent code in which the image is projected; train the second generator model using a sketch, among the dataset, corresponding to the deep feature map and the discriminator model; acquire an image having an identity and structure as an output of the first generator model; and acquire a sketch having the identity and the structure as an output of the second generator model.

In accordance with a fourth aspect of a non-transitory computer-readable storage medium storing a computer program, wherein the computer program, when executed by a processor, includes instructions for causing the processor to perform a method, the method comprising: projecting an image, from a dataset including sketch-image pairs, into a latent space of a first generator model of the generative adversarial network; applying a deep feature map of the first generator model to a second generator model of the generative adversarial network, using a latent code obtained in projecting the image into the latent space; and training the second generator model using a sketch, among the dataset, corresponding to the deep feature map and a discriminator model of the generative adversarial network.

In accordance with a fifth aspect of a computer program stored in a non-transitory computer-readable storage medium, wherein the computer program, when executed by a processor, includes instructions for causing the processor to perform a method, the method comprising: projecting an image, from a dataset including sketch-image pairs, into a latent space of a first generator model of the generative adversarial network; applying a deep feature map of the first generator model to a second generator model of the generative adversarial network, using a latent code obtained in projecting the image into the latent space; and training the second generator model using a sketch, among the dataset, corresponding to the deep feature map and a discriminator model of the generative adversarial network.

In accordance with a sixth aspect of a non-transitory computer-readable storage medium storing a computer program, wherein the computer program, when executed by a processor, includes instructions for causing the processor to perform a method for extracting a stylized sketch using a generative adversarial network, the generative adversarial network including a first generator model, a second generator model, and discriminator model, the method comprising: projecting an image, from a dataset including sketch-image pairs, into a latent space of the first generator model; applying a deep feature map of the first generator model to the second generator model, using a latent code in which the image is projected; training the second generator model using a sketch, among the dataset, corresponding to the deep feature map and the discriminator model; acquiring an image having an identity and structure as an output of the first generator model; and acquiring a sketch having the identity and the structure as an output of the second generator model.

In accordance with a seventh aspect of a computer program stored in a non-transitory computer-readable storage medium, wherein the computer program, when executed by a processor, includes instructions for causing the processor to perform a method for extracting a stylized sketch using a generative adversarial network, the generative adversarial network including a first generator model, a second generator model, and discriminator model, the method comprising: projecting an image, from a dataset including sketch-image pairs, into a latent space of the first generator model; applying a deep feature map of the first generator model to the second generator model, using a latent code in which the image is projected; training the second generator model using a sketch, among the dataset, corresponding to the deep feature map and the discriminator model; acquiring an image having an identity and structure as an output of the first generator model; and acquiring a sketch having the identity and the structure as an output of the second generator model.

According to an embodiment, in training the generative adversarial network, the generative adversarial network may be trained using a relatively small amount of sketch data by applying a feature map of a generator model projected with an image from a dataset including sketch-image pairs to a new generator model.

In addition, a stylized sketch may be extracted by using the generative adversarial network including a generator model to which a feature map of the generator model projected with an image among the dataset is applied, and a sketch of the corresponding style may be generated by mixing a style code into a latent code of the feature map, and conversely, an image of a specific style corresponding to a sketch of the specific style may also be generated, and a sketch in which a semantic element is manipulated while identity and style are maintained may also be generated by performing a manipulation of adding a known semantic latent direction to the latent code.

### BRIEF DESCRIPTION OF THE DRAWINGS

FIG. 1 is a configuration diagram of a stylized sketch apparatus using a generative adversarial network according to an embodiment of the disclosure.

FIG. 2 is a configuration diagram of the generative adversarial network used by the stylized sketch apparatus according to an embodiment of the disclosure.

FIG. 3 is a flowchart for explaining a training method of the generative adversarial network for a stylized sketch according to an embodiment of the disclosure.

FIG. 4 is a flowchart for explaining a method of extracting a stylized sketch using the generative adversarial network according to an embodiment of the disclosure.

FIG. 5 is a diagram comparing the performance of a variation of the training method of the generative adversarial network for a stylized sketch according to an embodiment of the disclosure.

FIG. 6 is a diagram illustrating sketches extracted in various styles according to the method of extracting a stylized sketch using the generative adversarial network according to an embodiment of the disclosure.

FIG. 7 is a diagram illustrating a result of converting a sketch into an image according to the method of extracting a stylized sketch using the generative adversarial network according to an embodiment of the disclosure.

FIG. 8 is a diagram illustrating a result of semantic editing of a sketch according to the method of extracting a stylized sketch using the generative adversarial network according to an embodiment of the disclosure.

### DETAILED DESCRIPTION OF THE INVENTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure.

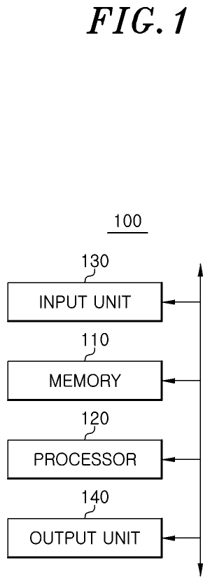

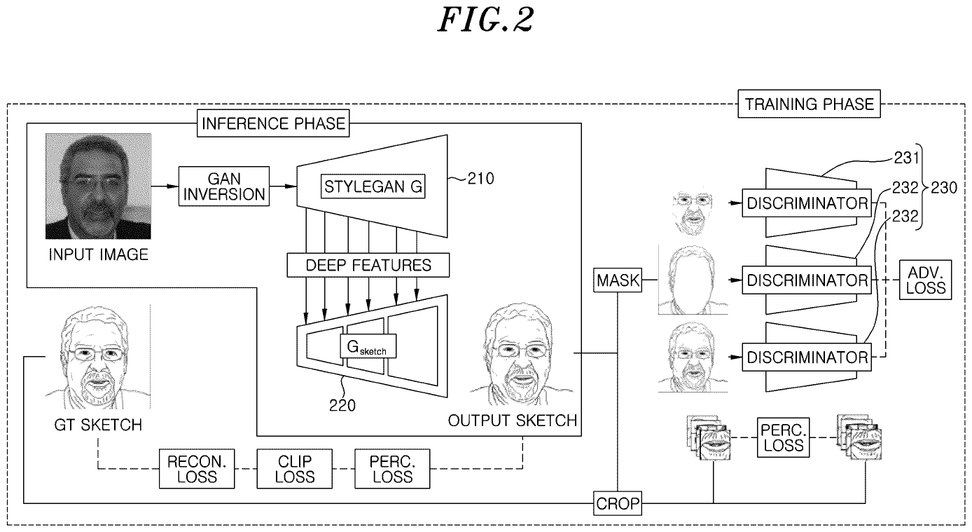

FIG. 1 is a configuration diagram of a stylized sketch apparatus using a generative adversarial network according to an embodiment of the disclosure, and FIG. 2 is a configuration diagram of the generative adversarial network used by the stylized sketch apparatus according to an embodiment of the disclosure.

Referring to FIGS. 1 and 2, a stylized sketch apparatus 100 using a generative adversarial network according to an embodiment includes a memory 110 and a processor 120, and may further include an input unit 130 and/or an output unit 140.

The memory 110 of the stylized sketch apparatus 100 may store a computer program including at least one instruction executable by the processor 120. The computer program is loaded by the execution of the instructions by the processor 120, allowing the processor 120 to perform a series of processes for training a generative adversarial network for a stylized sketch, and a series of processes for extracting stylized sketch using a trained generative adversarial network.

The processor 120 of the stylized sketch apparatus 100 executes the instructions of the computer program stored in the memory 110, thereby loading and executing the computer program to perform a method for training the generative adversarial network according to an embodiment and/or a method for extracting a stylized sketch using the trained generative adversarial network.

According to an embodiment, a generative adversarial network used for a stylized sketch by a processor 120 includes a first generator model 210, a second generator model 220, and a discriminator model 230, and the discriminator model 230 may include a plurality of discriminators 231, 232, and 233. The illustration of the three discriminators 231, 232, and 233 in FIG. 2 is merely exemplary and is not limited thereto.

The processor 120 projects an image from a dataset including sketch-image pairs into a latent space of the first generator model 210 of the generative adversarial network, and applies a deep feature map of the first generator model 210, using a latent code in which the image is projected, to the second generator model 220 of the generative adversarial network, and trains the second generator model 220 using a sketch corresponding to the deep feature map among the dataset and the discriminator model 230 of the generative adversarial network. A latent code is defined in the latent space. A latent code is generated in projecting the image into the latent space by encoding the image with the first generator model of the generative adversarial network. In a training process, an L1 loss function may be used for training until a preset number of training iterations, and the L1 loss function may be initialized and not used for training from subsequent training iterations. The discriminator model 230 may include the plurality of discriminators 231, 232, and 233, and each of the discriminators 231, 232, and 233 may receive a sketch output by the second generator model 220 as input in a whole or partial form and perform discrimination.

Further, the processor 120 acquires an image having a specific identity and structure as an output of the trained first generator model 210 of the generative adversarial network, and acquires a sketch having a specific identity and structure as an output of the trained second generator model 220 of the generative adversarial network, thereby extracting a stylized sketch corresponding to the image input to the first generator model 210.

In addition, the processor 120 may generate a sketch of a corresponding style by training an encoder that converts an sketch-image pair output by the first generator model 210 and the second generator model 220 into a latent code, and then by mixing a style code into the latent code of the trained encoder.

In addition, the processor 120 may generate an image of a specific style as an output of the trained encoder by inputting a sketch of the specific style into the trained encoder.

In addition, the processor 120 may generate a sketch in which a semantic element is manipulated while identity and style are maintained, as an output of the second generator model 220, by performing a manipulation of adding a known semantic latent direction to the latent code of the second generator model 220.

The input unit 130 of the stylized sketch apparatus 100 may provide the processor 120 with various types of information and/or data necessary to execute a method for training a generative adversarial network according to an embodiment and/or a method for extracting a stylized sketch using the trained generative adversarial network.

For example, the input unit 130 may include a data interface or a communication channel capable of receiving various types of information and/or data.

The output unit 140 of the stylized sketch apparatus 100 may output various processed data and results generated by the processor 120 while performing a method for training a generative adversarial network according to an embodiment and/or a method for extracting a stylized sketch using the trained generative adversarial network, and may provide them to an external device. For example, the output unit 140 may display the information visually, output it in data format through a serial interface, or transmit the data through a communication channel.

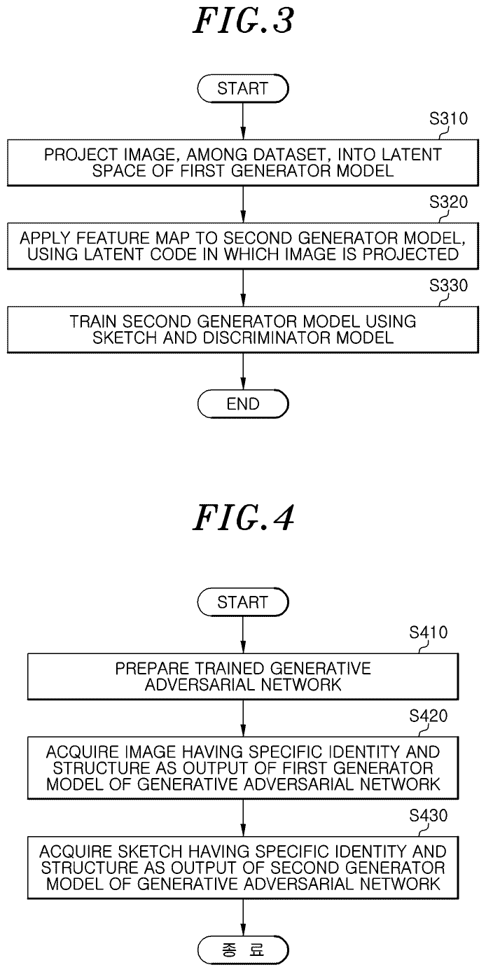

FIG. 3 is a flowchart for explaining a training method of the generative adversarial network for a stylized sketch according to an embodiment of the disclosure, and FIG. 4 is a flowchart for explaining a method of extracting a stylized sketch using the generative adversarial network according to an embodiment of the disclosure.

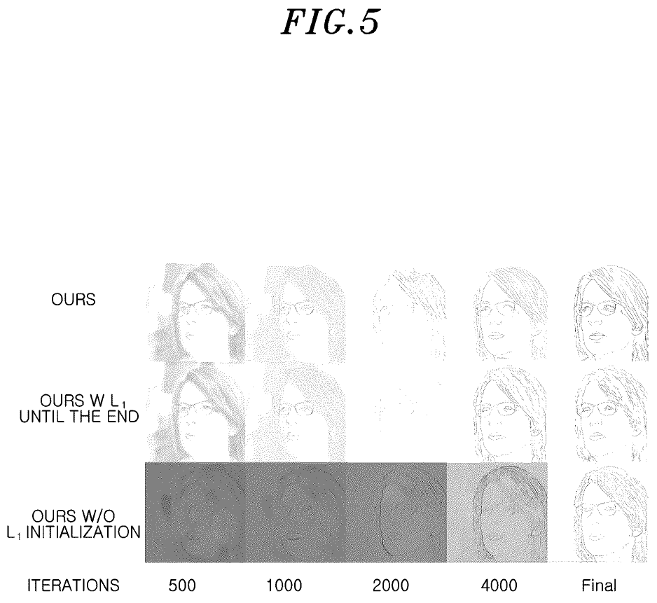

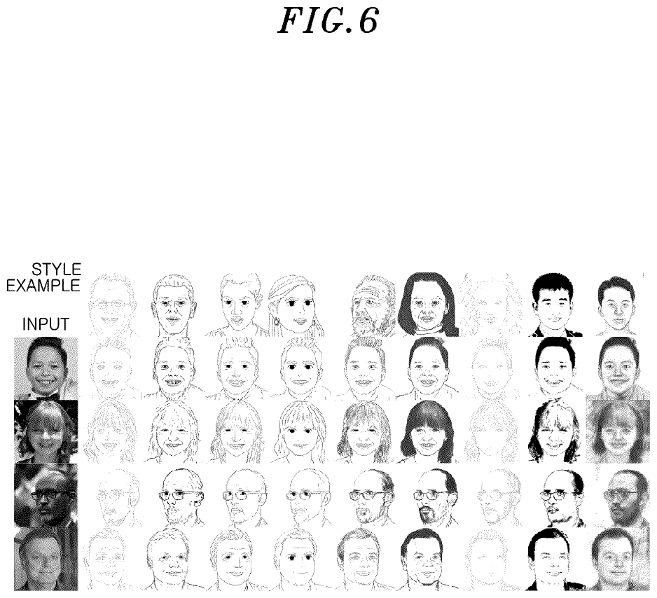

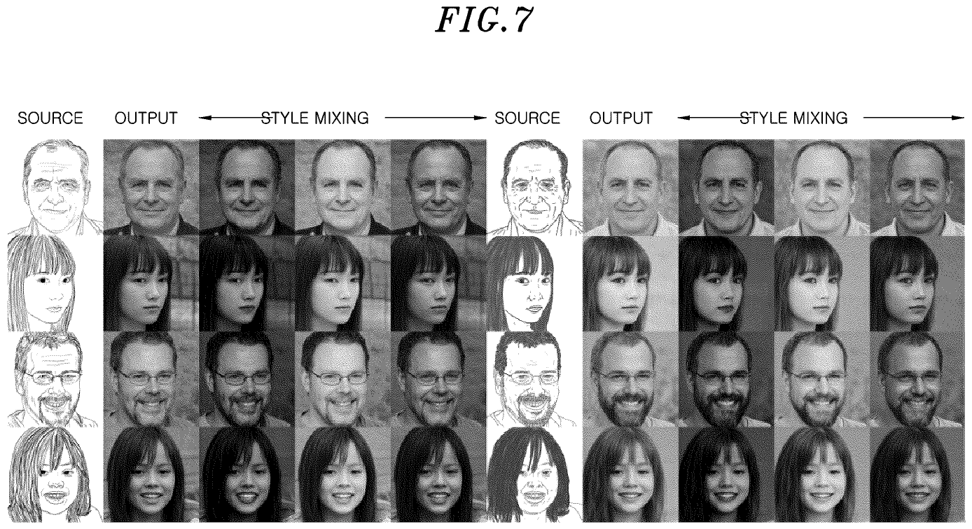

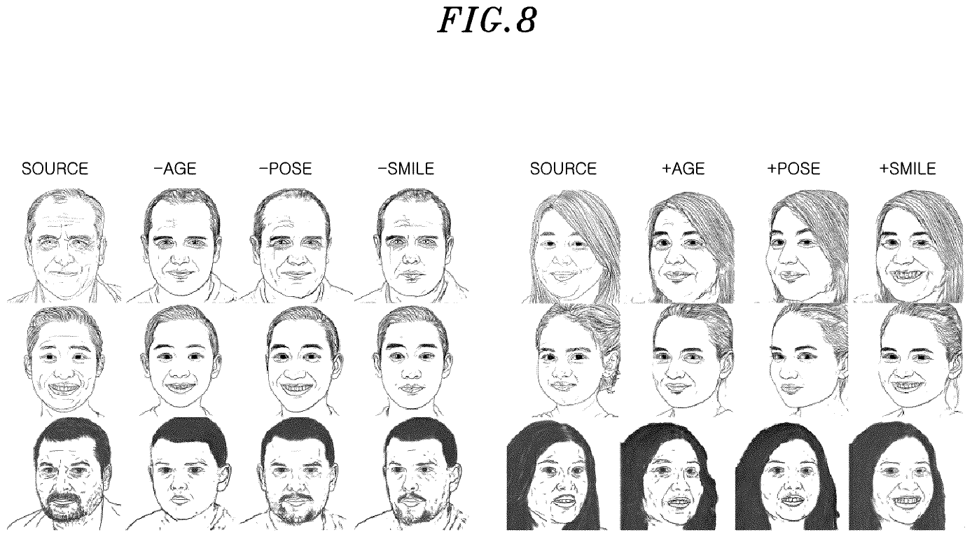

In addition, FIG. 5 is a diagram comparing the performance of a variation of the training method of the generative adversarial network for a stylized sketch according to an embodiment of the disclosure, FIG. 6 is a diagram illustrating sketches extracted in various styles according to the method of extracting a stylized sketch using the generative adversarial network according to an embodiment of the disclosure, FIG. 7 is a diagram illustrating a result of converting a sketch into an image according to the method of extracting a stylized sketch using the generative adversarial network according to an embodiment of the disclosure, and FIG. 8 is a diagram illustrating a result of semantic editing of a sketch according to the method of extracting a stylized sketch using the generative adversarial network according to an embodiment of the disclosure.

Hereinafter, with reference to FIGS. 1 through 8, a detailed description will be given of the training process of the stylized sketch apparatus using a generative adversarial network according to an embodiment of the present disclosure, as well as the process of extracting a stylized sketch using the trained generative adversarial network.

First, the processor 120 of the stylized sketch apparatus 100 may execute the instructions of a computer program stored in the memory 110 to load and run the computer program. Once the processor 120 has loaded and executed the computer program, it may perform a series of processes for training the generative adversarial network for stylized sketching, and a series of processes for extracting stylized sketches using the trained generative adversarial network.

A dataset including sketch-image pairs may be input through an input unit 130 of the stylized sketch apparatus 100, and may be stored in a memory 110, and the processor 120 projects an image among the dataset stored in the memory 110 or a dataset input in real-time through the input unit 130 into a latent space of the first generator model 210 of the generative adversarial network (S310).

In addition, the processor 120, through step S310, applies a deep feature map of the first generator model 210 to the second generator model 220 of the generative adversarial network, using a latent code in which the image is projected (S320).

Then, the processor 120 sets, among the dataset, a sketch corresponding to the deep feature map, i.e., a sketch paired with the image that was projected into the first generator model 210 in step S310 as a ground-truth (GT) sketch, and trains the second generator model 220 using the discriminator model 230 of the generative adversarial network (S330).

In step S330, the processor 120 may use the discriminator model 230 including the plurality of discriminators 231, 232, and 233. For example, in discriminating whether the face sketch output by the second generator model 220 is real or fake, one discriminator 231 may discriminate facial features, another discriminator 232 may discriminate the contour of the face, and still another discriminator 233 may discriminate the entire face. In this way, when the sketch is discriminated in whole or in part by using the plurality of discriminators 231, 232, and 233, effective training may be performed using a relatively smaller amount of data, compared to the case in which a single discriminator is used to discriminate the whole. For example, even within the same style, a manner of drawing hair may be different from a manner of drawing skin or other features of the face.

In addition, in a training process of step S330, the L1 loss function may be used for training until a preset number of training iterations, and the L1 loss function may be initialized and not used for training from subsequent training iterations. In this manner, by using the L1 loss function for training only until the preset number of training iterations and thereafter initializing the L1 loss function, the results of the case where the L1 loss function is no longer used for training and the case where initialization is not used, are compared in FIG. 5. When initialization is used (Ours), it can be seen that the result of step S430, which will be described below, is relatively superior compared to the case where initialization is not used at all or is only partially used.

Next, the processor 120 may extract a stylized sketch for an image by using the generative adversarial network that has been trained. To this end, the processor 120 prepares the trained generative adversarial network (S410).

Then, the processor 120 acquires an image having a specific identity and structure as an output of the first generator model 210 of the prepared generative adversarial network (S420).

Then, the processor 120 acquires a sketch having a specific identity and structure as an output of the second generator model 220 of the trained generative adversarial network, thereby acquiring a stylized sketch corresponding to the image input to the first generator model 210 (S430).

The stylized sketch acquired through step S430 may be output through an output unit 140 under the control of the processor 120. Here, the outputting may include visualizing the sketch so that it can be confirmed with the eyes, outputting the sketch in the form of data through a serial interface, or transmitting the sketch in the form of data through a communication channel or the like.

In addition, the processor 120 may generate a sketch of a corresponding style, as illustrated in FIG. 6, by training an encoder that converts an sketch-image pair output by the first generator model 210 and the second generator model 220 into a latent code, and then by mixing a style code into the latent code of the trained encoder. The trained encoder may convert the sketch while matching the identity and characteristics of the sketch and the original image.

In addition, as illustrated in FIG. 7, the processor 120 may generate an image of a specific style as an output of the trained encoder by inputting a sketch of the specific style into the trained encoder. Since a sketch does not convey color information, multi-modality is possible, and a predicted latent code may be mixed with a desired style code to generate face images of various styles similar to real photographs.

In addition, as illustrated in FIG. 8, the processor 120 may generate a sketch in which a semantic element is manipulated while identity and style are maintained, as an output of the second generator model 220, by performing a manipulation of adding a known semantic latent direction to the latent code of the second generator model 220. For example, semantic elements such as age, pose, and expression may be effectively manipulated while identity and style are maintained.

Meanwhile, the method for training a generative adversarial network for stylized sketching and/or the method for extracting a stylized sketch according to the above-described embodiments may be implemented as a computer program including instructions that cause the processor to perform each step included in the methods.

In addition, the computer program including instructions that cause the processor to perform each step of the method for training a generative adversarial network for stylized sketching and/or the method for extracting a stylized sketch according to the above-described embodiments may be recorded on a non-transitory computer-readable storage medium.

As described above, According to an embodiment, in training the generative adversarial network, the generative adversarial network may be trained using a relatively small amount of sketch data by applying a feature map of a generator model projected with an image from a dataset including sketch-image pairs to a new generator model.

In addition, a stylized sketch may be extracted by using the generative adversarial network including a generator model to which a feature map of the generator model projected with an image among the dataset is applied, and a sketch of the corresponding style may be generated by mixing a style code into a latent code of the feature map, and conversely, an image of a specific style corresponding to a sketch of the specific style may also be generated, and a sketch in which a semantic element is manipulated while identity and style are maintained may also be generated by performing a manipulation of adding a known semantic latent direction to the latent code.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable storage medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method for training a generative adversarial network for a stylized sketch, the method comprising:
projecting an image, from a dataset including sketch-image pairs, into a latent space of a first generator model of the generative adversarial network;
applying a deep feature map of the first generator model to a second generator model of the generative adversarial network, using a latent code obtained in projecting the image into the latent space; and
training the second generator model using a sketch, among the dataset, corresponding to the deep feature map and a discriminator model of the generative adversarial network.

2. The method of claim 1, wherein the training includes:
using an L1 loss function for training until a preset number of training iterations; and
initializing the L1 loss function not to be used for training from subsequent training iterations.

3. The method of claim 1, wherein, in the training, the discriminator model includes a plurality of discriminators, and each of the discriminators receives, as input, a sketch output by the second generator model, in whole or in part and discriminates the sketch.

4. A method for extracting a stylized sketch using a stylized sketch apparatus based on a generative adversarial network, the generative adversarial network including a first generator model, a second generator model, and discriminator model, the method comprising:
projecting an image, from a dataset including sketch-image pairs, into a latent space of the first generator model;
applying a deep feature map of the first generator model to the second generator model, using a latent code in which the image is projected;
training the second generator model using a sketch, among the dataset, corresponding to the deep feature map and the discriminator model;
acquiring an image having an identity and structure as an output of the first generator model; and
acquiring a sketch having the identity and the structure as an output of the second generator model.

5. The method of claim 4, wherein an encoder that converts an sketch-image pair output by the first generator model and the second generator model into a latent code is trained, and a style code is then mixed into a latent code of the trained encoder to generate a sketch of a corresponding style.

6. The method of claim 5, wherein a sketch of a predetermined style is input into the trained encoder, and an image of the predetermined style is generated as an output of the trained encoder.

7. The method of claim 4, wherein a sketch in which a semantic element is manipulated while identity and style are maintained is generated as the output of the second generator model by performing a manipulation of adding a known semantic latent direction to the latent code of the second generator model.

8. A stylized sketch apparatus based on a generative adversarial network, the generative adversarial network including a first generator model, a second generator model, and discriminator model, the apparatus comprising:
a memory storing at least one instruction; and
a processor executing the at least one instruction stored in the memory,
wherein the at least one instruction, when executed by the processor, causes the processor to:
project an image, from a dataset including sketch-image pairs, into a latent space of the first generator model;
apply a deep feature map of the first generator model to the second generator model, using a latent code in which the image is projected;
train the second generator model using a sketch, among the dataset, corresponding to the deep feature map and the discriminator model;
acquire an image having an identity and structure as an output of the first generator model; and
acquire a sketch having the identity and the structure as an output of the second generator model.

9. The apparatus of claim 8, wherein an encoder that converts an sketch-image pair output by the first generator model and the second generator model into a latent code is trained, and a style code is then mixed into a latent code of the trained encoder to generate a sketch of a corresponding style.

10. The apparatus of claim 9, wherein a sketch of a predetermined style is input into the trained encoder, and an image of the predetermined style is generated as an output of the trained encoder.

11. The apparatus of claim 8, wherein a sketch in which a semantic element is manipulated while identity and style are maintained is generated as the output of the second generator model by performing a manipulation of adding a known semantic latent direction to the latent code of the second generator model.
